(19) United States
(12) Patent Application Publication
(10) Pub. No.: US 2009/0084487 A1
(43) Pub. Date: Apr. 2, 2009

(54) Manufacturing method of laminated film and multilayer ceramic electronic device thereof

(75) Inventors: Tadayoshi Iijima, Narita (JP); Shuji Iida, Narita (JP)

Correspondence Address: OLIFF & BERRIDGE, PLC, P.O. BOX 320850, ALEXANDRIA, VA, 22320-4850, US

(73) Assignee: TDK CORPORATION, TOKYO (JP)

(21) Appl. No.: 12/232,649

(22) Filed: Sep. 22, 2008

(30) Foreign Application Priority Data
Sep. 28, 2007 (JP) 2007-255587

(51) Int. Cl. C04B 35/00; B32B 27/36; B32B 27/00; B05D 5/12

(52) U.S. Cl. 156/89.12; 428/480; 428/704; 427/58; 428/447

(57) ABSTRACT

A laminated film of the invention comprises a core layer made of synthetic resin, and a conductive release layer formed on at least one side of the core layer, wherein the conductive release layer comprises condensation reaction type release binder and conductive polymer, and this laminated film of the invention is preferably used as a process film when manufacturing ceramic green sheet by sheet-forming a ceramic material slurry; is able to manufacture a thin ceramic green sheet constantly having an uniform thickness; and is superior in antistatic and release properties.

### BACKGROUND OF THE INVENTION

1. Field of the Invention

The present invention relates to a manufacturing method of a laminated film and a multilayer ceramic electronic device, and further, to the same of a laminated film, which is preferably used when manufacturing ceramic green sheet by sheet-forming ceramic material slurry and is superior in antistatic and release properties, and a multilayer ceramic electronic device wherein the device is manufactured with the laminated film.

2. Description of the Related Art

Multilayer ceramic capacitor and multilayer ceramic electronic device, such as ceramic multilayer substrate, are generally manufactured by the steps of laminating ceramic green sheet, pressuring, heat treating, and sintering ceramic or electrode.

Ceramic green sheet used for manufacturing multilayer ceramic electronic device is generally manufactured by the following steps: compounding ceramic powder with dispersing medium (solvent), dispersant, binder and plasticizer in a predetermined ratio, mixing and crushing with medium type dispersing device such as beads mill, ball mill, attritor, paint shaker and sand mill to make ceramic slurry, forming process film (also called as carrier film) having a predetermined thickness with doctor blade method or so, and drying. And as the process film, synthetic resin sheet of polyethylene terephthalate including fillers such as inorganic powder or organic powder having a particle diameter of a few μm is generally used. Filler is added in order to improve strength and running property (sliding property) of the process film.

Recently, there have been demands for various kinds of multilayer ceramic electronic device such as multilayer ceramic capacitor, as is the same with the other electronic devices, that they downsize and show higher performance. Therefore, ceramic green sheet used for manufacturing a multilayer ceramic electronic device is required to be thinner, and in recent years, extremely thin ceramic green sheet having a thickness of 3 μm or less is desired for the manufacturing process.

However, there are high projections of filler on the surface of the process film wherein the filler having a particle diameter of a few μm is included; resulting in the problem that recess having a depth of approximately 0.3 to 2 μm or pin hole may be formed on the ceramic green sheet. And when said recess or pin hole is made on the green sheet, problems such as short-circuit between internal electrodes or reduction of reliability may occur in the final product such as multilayer ceramic capacitor. Thus, when ceramic green sheet is made thinner, it tends to be effected by unevenness formed on surface of the process film.

Considering above, by reducing the amount of filler composed in the process film and suppressing the formation of unevenness on the process film wherever possible, it may be possible to reduce the effect of the unevenness. However, when the amount of the filler is reduced, the strength of the process film reduces and the process filler tends to be damaged at running. Especially, a process film having a flattened surface tends to be damaged since a contact area, such as with a roller, increases and running property of the process film decreases. Further, since a contact area with roller increases, it is likely to electrify when rolling and unrolling. Due to static electricity caused by the electrification, coating of ceramic slurry may become ununiform or contaminant may be mixed. Further, the ceramic green sheet or the process film may deteriorate due to discharge of static electricity caused by the electrification.

Patent article 1 (Japanese unexamined patent application No. 2002-121075) discloses a laminated film wherein a release layer is placed on a surface and projection of 1 μm or more in height is substantially not existing on ceramic slurry coating surface. With this laminated film, however, antistatic property is insufficient and the above-mentioned problems caused by static electricity cannot be solved.

Patent article 2 (Patent No. 3870785) discloses a laminated film wherein a release layer is formed on ceramic slurry coating face and said face has the maximum height, Rmax, of 0.2 μm or less. Patent article 2 further discloses at least one face of the laminated film comprises antistatic layer. Patent article 2, however, is required to form release layer and antistatic layer separately, which makes the manufacturing method complicated.

Patent article 3 (Japanese unexamined patent application No. 2007-152930) discloses an antistatic polyester film having polyester film, antistatic coating layer formed on the film and silicone resin release layer laminated on the antistatic layer. With this antistatic film, however, as is the same with the patent article 2, formation of release layer and the same of antistatic layer should be carried out separately, which makes the manufacturing method complicated.

Patent article 4 (Japanese unexamined patent application No. 2007-190717) discloses a release film, having an antistatic release agent layer including carbon nanofiber, on at least one face of a substrate film. Due to the carbon nanofiber used, continuity route is likely to be formed in this release film. Said fiber, however, has a length of approximately 1 μm and that the fiber is likely to form projection when applied, which leads to deterioration of smooth property on the release film surface. Accordingly, when said release film is used for manufacturing green sheet, recess or pin hole may occur on green sheet. Further, a coating liquid to form antistatic release agent layer is filtered to remove contaminant included in the coating liquid before coating, however, with a carbon nanofiber coating liquid, the carbon nanofiber is likely to be captured by the filter leading to a reduction of working efficiency

### SUMMARY OF THE INVENTION

An object of the present invention, reflecting the situation of prior art, is to provide a laminated film which is preferably used when manufacturing ceramic green sheet by sheet-forming a ceramic material slurry, is capable of manufacturing a thin ceramic green sheet constantly having an uniform thickness and is superior in antistatic and release properties. Further, the other object of the present invention is to provide a manufacturing method of a multilayer ceramic electronic device in which the laminated film is used as a process film wherein the electronic device causes less short-circuit even with thin dielectric layer.

In order to solve the above problems, the present invention includes the following outlines.
(1) A laminated film comprising:
   a core layer made of synthetic resin, and
   a conductive release layer formed on at least one side of the core layer, wherein the conductive release layer comprises condensation reaction type release binder and conductive polymer.
(2) The laminated film as set forth in above (1), wherein the condensation reaction type release binder has cross-linked structure formed by condensation reaction.
(3) The laminated film as set forth in above (1) or (2), wherein the condensation reaction type release binder is aminoalkyd resin.
(4) The laminated film as set forth in above (3), wherein the aminoalkyd resin is silicone modified aminoalkyd resin.
(5) The laminated film as set forth in above (1), wherein the conductive polymer is polypyrrole.
(6) The laminated film as set forth in above (1), wherein a mass ratio of the conductive polymer and the condensation reaction type release binder in the conductive release layer, the conductive polymer/the condensation reaction type release binder, is 1/4 to 1/1.
(7) The laminated film as set forth in above (1), wherein the maximum peak height (Rp) of the core layer surface is 200 nm or less.
(8) The laminated film as set forth in above (1), wherein the synthetic resin is polyethyleneterephthalate.
(9) The laminated film as set forth in above (1), wherein a filler is substantially not included in the core layer.
(10) A manufacturing method of the laminated film as set forth in above (1), comprising:
   a step of filtering a coating liquid for forming the conductive release layer including a precursor of the condensation reaction type release binder and the conductive polymer,
   a step of coating and drying the filtrate on at least one side of the core layer made of synthetic resin, and
   a step of curing the precursor of the condensation reaction type release binder by condensation reaction.
(11) A manufacturing method of a multilayer ceramic electronic device comprising:
   a step of pulling out the laminated film as set forth in any one of above (1) to (9) from a roll which rolls up the laminated film,
   a step of forming a green sheet on the laminated film surface,
   a step of removing said green sheet from the surface of laminated film,
   a step of stacking the green sheets to form a multilayer body, and
   a step of firing the multilayer body.
(12) The manufacturing method of a multilayer ceramic electronic device as set forth in above (11), further comprising a step of forming an electrode pattern layer on the green sheet surface.

According to the present invention, a laminated film preferably used at a coating step of ceramic green sheet and capable of manufacturing thin ceramic green sheet constantly having a uniform thickness is provided

### BRIEF DESCRIPTION OF THE DRAWINGS

Hereinafter, the present invention will be described based on embodiments shown in the drawings.

FIG. 1 is a cross-sectional schematic view of a laminated film according to an embodiment of the present invention.

FIG. 2 is a schematic view of a green sheet forming process using the laminated film shown in FIG. 1.

FIG. 3 is a consecutive schematic view of the process shown in FIG. 2.

FIG. 4 is a cross-sectional schematic view of a multilayer ceramic capacitor.

### DESCRIPTION OF THE PREFERRED EMBODIMENTS

Laminated Film

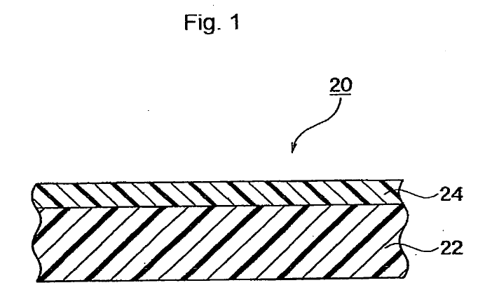

Laminated film 20 according to an embodiment of the invention comprises a conductive release layer 24 formed on at least one side of the core layer 22 as shown in the cross-sectional schematic view of FIG. 1. For core layer 22, an easily drawn thermoplastic resin sheet, which can be various resin sheets conventionally used for carrier sheet (laminated film) when manufacturing green sheet and can be used without any limitation, is preferable.

Thermoplastic resin is a general term for a sheet which melts or softens by heat, and is not specifically limited. As representatives of said thermoplastic resin, polyolefin sheet such as polyester sheet, polypropylene sheet and polyethylene sheet, acrylic sheet such as polylactic acid sheet, polycarbonate sheet, poly-methyl-methacrylate sheet and polystyrene sheet, polyamide sheet such as nylon, polyvinyl chloride sheet, polyurethane sheet, fluoro sheet, and poly-phenylene sulfide sheet can be used.

The thermoplastic resin sheet can be homopolymer or copolymer. Among the sheets, polyester sheet, polypropylene sheet and polyamide sheet are preferable for their mechanical property, dimension stability, clarity, etc. and further, polyester sheet is especially preferable for its mechanical strength and general-purposes.

Polyester is a general term for polymers wherein their main chains are mainly linked by ester bonds. Preferable polyesters comprises at least one component selected from ethylene terephthalate, propylene terephthalate, ethylene-2,6-naphthalate, butylene terephthalate, propylene-2,6-naphthalate, and ethylene-α,β-bis(2-chlorophenoxy)ethane-4,4′-dicarboxylate, etc. as main component. Only one component or two or more components can be used at a time, however, synthetically concerning quality and economical efficiency, etc. of the components, polyesters mainly composed of ethylene terephthalate, i.e. polyethylene terephthalate is the most preferable. Further, when used to apply heat or shrinkage stress to the laminated film, polyethylene-2,6-naphthalate, superior in heat resistance and stiffness, is further preferable.

These polyester can partially, preferably 20 moles % or less, be copolymerized with the other dicarboxylate or diol components. When manufacturing core layer 22 with polyester, polyester having limiting viscosity (measured in o-chlorophenol at 25° C.) of 0.4 to 1.2 dl/g is preferable and 0.5 to 0.8 dl/g is more preferable, since the polyester within such range shows superior formation property.

Core layer 22 may further include various additives, such as anti-oxidizing agent, heat resisting stability agent, weathering agent, ultraviolet absorbing agent, organic lubricant, pigment, coloring agent, organic or inorganic fine particles, filler, antistatic agent, and nucleating agent, up to a certain amount so as not to deteriorate its characteristics. Core layer 22 may further include inorganic filler, such as silica, colloidal silica, alumina, alumina sol, kaolin, talc, mica, calcium carbonate, vanadium sulfate, carbon black, zeolite, titanium oxide, and metal fine particle and organic filler. By composing said filler, strength and sliding (lubricant) property improves. On the other hand, component of the filler deteriorates a sheet surface smoothness; therefore, in the present invention, it is preferable to reduce an amount of filler composed in the sheet wherever possible, and is more preferable substantially not to include the filler in a sheet. Sheet wherein the filler is substantially not included generally has a low strength and sliding property, therefore, it may be damaged when running, drawing, rolling and unrolling. Therefore, core layer 22 can be a compound sheet comprising two or more layers of inner and outer layers. Core layer 22, for instance, may be a complex sheet comprising inner layer including the filler and outer layer substantially not including the filler. Further, inner and outer layers of the above complex sheet may be the same or different kind of polymers.

The term “the filler is substantially not included” is for a core layer surface having Ra of 10 nm or less and Rp of 200 nm or less when measured with Micromap System (an optical interference style three-dimensional non-contact surface configuration measuring system) by Ryoka System Inc.

The maximum peak height (Rp) of core layer 22 surface is preferably 200 nm or less, more preferably, 100 nm or less. The present inventors were the first ones to find that pin hole or locally thin-layered part of green sheet formed on a laminated film surface can effectively be prevented by determining the maximum peak height (Rp). Note that the maximum peak height (Rp) is determined by JIS B0601. When core layer 22 includes the filler, due to the height of filler, the maximum peak height (Rp) on core layer 22 surface is difficult to be prescribed value or less. Especially when filler, having a particle diameter of more than 200 nm, is included in core layer 22, it becomes difficult to make the maximum peak height (Rp) to a prescribed value or less. Accordingly, as mentioned above, core layer 22 of the invention is preferable substantially not to include the filler.

Further, core layer 22 in laminated film 20 of the invention is preferably a biaxially oriented sheet. Biaxially oriented sheet is generally made by drawing a sheet-before-drawing (raw fabric sheet) to longitudinal and latitudinal directions approximately to 2.5 to 5 times long, respectively and heat-treating to complete crystal orientation, wherein the sheet shows biaxially oriented pattern when measured by a wide angle X-ray diffraction. Said biaxially oriented sheet may be formed simultaneously with a conductive release layer by an inline process mentioned below.

Thickness of core layer 22 is not particularly limited and suitably determined considering mechanical strength, handling property, etc. but generally 1 to 500 μm is preferable, 5 to 300 μm is more preferable and 9 to 210 μm is the most preferable.

Laminated film 20 comprises a conductive release layer 24 on at least one side of core layer 22. It is sufficient to provide a conductive release layer 24 on a coating side of ceramic slurry, however, in order to improve strength, antistatic, running and sliding properties of laminated film 20, conductive release layer 24 can be provided on both sides of core layer 22.

Conductive release layer 24 comprises conductive polymer and condensation reaction type release binder.

The conductive polymer is a polymer wherein polymer itself has conductive property and does not include a conductive resin composition wherein conductive property is given by conductive additives, e.g. metal particles and carbon black. With the conductive resin composition, the conductive additives may be moved to ceramic green sheet formed on conductive release layer 24 which leads to the deterioration of insulation and dielectric properties of ceramic layer when fired. Further, with theses conductive additives, uneven surface may be formed on conductive release layer 24. The unevenness leads to deterioration of smooth property on laminated film surface and recess or pin hole occur on green sheet.

For conductive polymer used in the invention, various kinds of conductive polymers, such as polyacetylene, polythiophene, polypyrrole, polyaniline, poly-phenylene vinylene, polyacene, can be used without any limitation. Above all, polythiophene, polypyrrole and polyaniline, especially polypyrrole, are preferable for their superiority in conductive and general-purpose properties.

Polypyrrole is a conductive polymer represented by the following structural formula and is generally added with dopant. For the dopant, organic sulfonic acid, for example, is used.

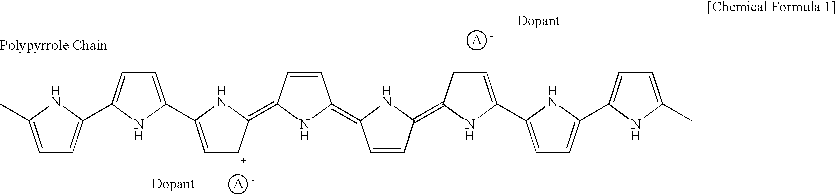

The condensation reaction type release binder is a release type polymer having crosslinked structure formed by condensation reaction. For the release polymer, well-known release agents such as alkyd resin polymer, silicone polymer, long chain alkyl polymer, fluorocarbon polymer, acryl polymer, polyolefin polymer and silicone or fluoro modified thereof can be exemplified. These release polymers themselves function as release agent as well as binder of the above conductive polymer. Polymers formed by condensation reaction are polymers crosslinked by condensation reaction accompanied with dehydration or dealcoholization. Condensation reaction type polymers are obtained by crosslinking precursor having methoxy group, ethoxy group, silanol group, OH group, methylol group, isocyanate group, epoxy group or (meta) acrylate group with condensation reaction accompanied by dehydration or dealcoholization. Crosslinker may be added during condensation reaction. For instance, a precursor having methoxy group may be crosslinked with a crosslinker having silanol group. Suitable curing catalyst may be added during condensation reaction where necessary. Above all, in the invention, alkyd resin release agent is preferably used for condensation reaction type release binder.

For alkyd resin release agent, alkyd resin having crosslinked structure is generally used. Formation of alkyd resin layer having crosslinked structure may be performed by heat curing a layer including heat curing resin composition comprising alkyd resin, crosslinker and curing catalyst, if required.

Alkyd resin is not particularly limited and can be suitably selected from a conventionally well-known alkyd resin. The alkyd resin is a resin obtained from condensation reaction of polyhydroxy alcohol and polybasic acid including inconvertible alkyd resin, a condensate of dibasic acid and dihydroxy alcohol or a material modified with non-drying oil aliphatic acid, and convertible alkyd resin including a condensate of dibasic acid and alcohol having the three or more hydroxyl groups, and both of the above resins can be used in the invention. In the invention, silicone modified alkyd resin is the most preferable for the invention.

To improve toughness and wettability of the release layer, acrylic resin may be included. An acrylic resin partially modified with silicone can further be used. For the acrylic resin, polyacrylic acid, poly methacrylate, poly methyl methacrylate, etc. can be exemplified.

For polyhydroxy alcohol, used as a material of the alkyd resin, dihydroxy alcohol, such as ethylene glycol, diethylene glycol, triethylene glycol, propylene glycol, trimethylene glycol, tetramethylene glycol and neopentyl glycol, trihydroxy alcohol, such as glycerin, trimethylolethane and trimethylolpropane, and alcohol having four or more hydroxyl groups, such as diglycerol, triglycerol, pentaerythritol, dipentaerythritol, mannitol and sorbit, can be exemplified. These alcohols may be used alone or a combination of two or more may be used.

For polybasic acid, aromatic polybasic acid, such as phthalic anhydride, terephthalic acid, isophthalic acid and trimellitic anhydride, saturated aliphatic polybasic acid, such as succinic acid, adipic acid and sebacic acid, unsaturated aliphatic polybasic acid, such as maleic acid, maleic anhydride, boletic acid, itaconic acid and citraconic anhydride, polybasic acid obtained by Diels-Alder reaction, such as cyclopentadiene-maleic anhydride addition product, terpene-maleic anhydride addition product and rosin-maleic anhydride addition product, can be exemplified. These polybasic acids may be used alone or a combination of two or more may be used.

For modifying agent, octyl acid, lauric acid, palmitic acid, stearic acid, olein acid, linoleic acid, linolenic acid, eleostearic acid, ricinoleic acid, and dehydrated ricinoleic acid, or palm oil, linseed oil, China wood oil, castor oil, dehydrated castor oil, soy bean oil, safflower oil and aliphatic acid thereof can be used. These modifying agents may be used alone or a combination of two or more may be used. Further, the alkyd resin may be a silicone modified alkyd resin. Above all alkyd resins, especially silicone modified alkyd resin is preferably used in the invention. In the invention, one kind or a combination of two or more kinds of alkyd resin may be used.

For crosslinker, other than amino resin, such as melamine resin and urea resin, urethane resin, epoxy resin and phenol resin may also be exemplified. Above all, aminoalkyd resin crosslinked by amino resin is preferably used. In the invention, one kind or a combination of two or more kinds of crosslinker may be used.

Ratio of alkyd resin and crosslinker in the preferably used alkyd resin release agent is preferably within the range of 70:30 to 10:90 when calculated by solid content mass ratio. Alkyd resin rate over said range is unable to provide a sufficient crosslinked structure in cured material which leads to a reduction of release property, while below said range tends to make the cured material hard and fragile which also leads to a reduction of release property. Ratio of alkyd resin and crosslinker is preferably within the range of 65:35 to 10:90, more preferably, 60:40 to 20:80 when calculated by solid content mass ratio.

For alkyd resin release agent, an acid catalyst can be used as curing catalyst. The acid catalyst is not particularly limited and can suitably be selected from a well-known acid catalysts conventionally known as its catalysis for crosslinking alkyd resin. For the acid catalyst, organic acid catalyst such as p-toluenesulfonic acid and methanesulfonic acid is preferable. The acid catalyst may be used alone or a combination of two or more may be used. Further, amount of said catalyst is generally 0.1 to 40 parts by mass, preferably 0.5 to 30 parts by mass, more preferably 1 to 20 parts by mass with respect to 100 parts by mass of the total amount of alkyd resin and crosslinker.

When conductive layer using coating conductive polymer is formed by coating, dispersions of conductive polymer is generally used, since conductive polymer is insoluble in solvent. However, coating and drying a dispersion including only conductive polymer still shows extremely low mechanical properties, e.g. resistance to scratch, and no release property as well. Therefore, as mentioned in the invention, dispersing and mixing a conductive polymer into a precursor solution of condensation reaction type release binder will make coating liquid uniform. Conductive release layer, wherein conductive polymer and condensation reaction type release binder is uniformly mixed, is obtained through coating, drying and heating the above coating liquid and forming crosslinking structure in condensation reaction type release binder by condensation reaction of precursor. The conductive release layer is superior in conductive property, mechanical properties such as resistance to scratch, solvent-resistance property and release property.

The release polymer may be formed through addition reaction, however, the addition reaction is inhibited by contaminant. Therefore, the addition reaction of a mixture including conductive polymer and dopant is extremely difficult.

The mass ratio of the conductive polymer and the condensation reaction type release binder in conductive release layer 24, the conductive polymer/the condensation reaction type release binder, is preferably 1/4 to 1/1, more preferably 1/3 to 1/1. The mass ratio of the conductive polymer and the condensation reaction type release binder within the above range derives a conductive release layer especially superior in antistatic property and release property. On the other hand, too large amount of said conductive polymer may lead to deterioration in release property and also too large amount of release binder may cause reduction in conductive property.

Lower electrical resistance in conductive release layer 24 shows greater antistatic effect, however, too low electrical resistance is not preferable since electrical current become extremely rapid. Considering above, electric resistance of conductive release layer 24 is preferably 10⁵ Ω/□ to 10¹¹ Ω/□.

Further, conductive release layer 24 has a moderate release property. Said release property is evaluated by a contact angle toward pure water, and preferable contact angle of conductive release layer 24 toward pure water is 90° or more, more preferably 95° or more.

The thickness of the conductive release layer 24 is particularly not limited, however, 0.01 to 2 μm is preferable, 0.05 to 1 μm is more preferable, 0.05 to 0.2 μm is the most preferable.

The conductive release layer 24 has a high coating suitability of ceramic slurry, therefore, when coating ceramic slurry, cissing and nonuniformity will not occur and ceramic green sheet having uniform thickness can be obtained. Further, the obtained ceramic green sheet has a good release property; therefore, without breaking the ceramic green sheet formed on conductive release layer 24, the green sheet can be released from laminated film 20. Furthermore, conductive release layer 24 is also superior in resistance to scratch. Before coating ceramic slurry, in order to clear waste from the surface of laminated film 20, cleaning cloth treatment is generally performed. According to laminated film 20 of the invention, conductive release layer 24 will not be removed by the cleaning cloth treatment.

Manufacturing method of a laminated film 20 of the invention is not particularly limited. For instance, the laminated film of the invention can be obtained by methods comprising: a step of filtering the below mentioned coating liquid for forming the conductive release layer including a precursor of the condensation reaction type release binder and the conductive polymer, a step of coating and drying the filtrate on at least one side of the core layer made of synthetic resin, and a step of curing the precursor of the condensation reaction type release binder by condensation reaction.

In terms of easiness in manufacturing and increase in quality of laminated film 20, a manufacturing method of so-called inline process is preferable. With the inline process, core layer 22 and conductive release layer 24 can be formed simultaneously, which simplify the process, and a homogeneous conductive release layer having uniform thickness can be obtained. Further, with the inline process, since conductive release layer 24 provides antistatic, release and sliding properties, damage to laminated film 20 when unrolling or running will be reduced.

According to inline process, at first, a coating liquid including a precursor of condensation reaction type release binder and a conductive polymer is prepared. The coating liquid may include crosslinker and/or condensation catalyst (curing catalyst). Said curing catalyst is suitably selected considering characteristics of precursor of condensation reaction type release binder. The coating liquid is prepared by mixing the above component and suitable amount of solvent, if required. After the preparation, filtration is performed to remove contaminants.

Apart from above, a resin sheet (raw fabric sheet) before crystal orientation is prepared. Raw fabric sheet is a cooled and solidified sheet after melt extrusion of resin material and does not have crystal orientation. The raw fabric sheet may be rolled to a roll state or the cooled and solidified sheet after melt extrusion of resin material may be used without rolling.

According to the inline process, for instance, raw fabric sheet is drawn to a longitudinal direction and coating liquid is continuously coated to 1-dimensional drawing sheet. The coated sheet is dried while passing through a gradually heated zone and drawn to a latitudinal direction. Further, the sheet is continuously lead to the heated zone completing the crystal orientation and forming core layer 22 while forming conductive release layer 24 by condensation reaction of coating liquid. Note that it is a general method to draw to a longitudinal direction, coat the coating liquid and draw to a latitudinal direction, however, various methods, such as to draw to a latitudinal direction, coat and draw to a longitudinal direction, or to coat and draw simultaneously to longitudinal and latitudinal directions may be used. Drawing factor to longitudinal and latitudinal directions is not particularly limited, but is generally around 2.5 to 5 times long. Heating temperature at heated zone is varied according to properties of resin forming core layer 22 and reaction temperature of release polymer precursor, however, is generally around 150 to 250° C.

Before coating the coating liquid, it is preferable to perform corona discharge treatment or so on sheet surface (1-dimentional drawing sheet in the above example) to make wet tension of the sheet surface to preferably 47 mN/m or more, more preferably, 50 mN/m or more in order to improve coating property of the coating liquid and adhesive property between the sheet and the coat. It is also preferable to include some amount of organic solvents such as isopropyl alcohol, butylcellosolve and N-methyl-2-pyrolidone, etc. in coating liquid in order to improve adhesive property between the sheet and the coat.

Coating method of the coating liquid on a sheet can be various kinds, such as a reverse coat method, a gravure coat method, a rod coat method, a bar-coat method, a mayer bar coat method, a dye coat method and a spraying coat method, etc.

Manufacturing Method of Multilayer Ceramic Capacitor

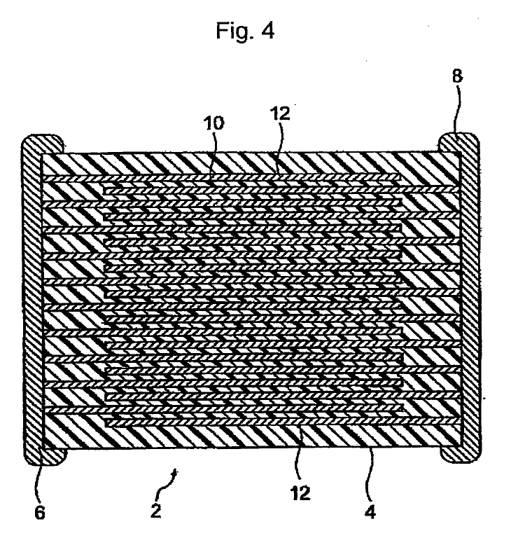

Next, manufacturing method of multilayer ceramic capacitor 2 shown in FIG. 4 using the above laminated film 20 will be described. First, multilayer ceramic capacitor 2 as shown in FIG. 4 will be described.

As shown in FIG. 4, multilayer ceramic capacitor 2 has capacitor element body 4, the first terminal electrode 6 and the second terminal electrode 8. The capacitor element body 4 comprises dielectric layers 10 and internal electrode layers 12, and the internal electrode layers 12 are alternately stacked between the dielectric layers 10. The alternately stacked internal electrode layers 12 on one side are electrically connected to inside of the first terminal electrode 6 formed outside of a first end portion of the capacitor element body 4. Also, the alternately stacked internal electrode layers 12 on the other side are electrically connected to inside of the second terminal electrode 8 formed outside of a second end portion of the capacitor element body 4.

A material of the dielectric layers 10 is not particularly limited and it may be composed of dielectric materials, such as calcium titanate, strontium titanate and/or barium titanate. A thickness of each dielectric layer 10 is not particularly limited but is generally several μm to hundreds of μm. Particularly in this embodiment, it is made as thin as preferably 5 μm or thinner, more preferably 3 μm or thinner, and particularly preferably 1.0 μm or thinner.

Also, a material of the terminal electrodes 6 and 8 is not particularly limited and copper, copper alloys, nickel and nickel alloys, etc. are normally used. Silver and an alloy of silver and palladium, etc. may also be used. A thickness of the terminal electrodes 6 and 8 is not particularly limited and is normally 10 to 50 μm or so.

A shape and size of the multilayer ceramic capacitor 2 may be suitably determined in accordance with the use object. When the multilayer ceramic capacitor 2 has a rectangular parallelepiped shape, it is normally a length (0.6 to 5.6 mm, preferably 0.6 to 3.2 mm)×width (0.3 to 5.0 mm, preferably 0.3 to 1.6 mm)×thickness (0.1 to 1.9 mm, preferably 0.3 to 1.6 mm) or so.

Next, an example of manufacturing methods of multilayer ceramic capacitor 2 according to the present embodiment will be explained. First, dielectric paste (paste for green sheet) is prepared in order to manufacture ceramic green sheet constituting dielectric layer 10 as shown in FIG. 4 after firing. The dielectric paste is composed of organic solvent paste obtained by mixing dielectric material (ceramic powder) and organic vehicle.

The dielectric material may be suitably selected from composite oxides and a variety of compounds to be oxides, for example, carbonates, nitrites, hydroxides and organic metal compounds, etc. and mixed for use. The dielectric material is normally used as a powder having an average particle diameter of 0.4 μm or less, preferably around 0.1 to 3.0 μm. To form an extremely thin green sheet, it is preferable to use a finer powder than a thickness of the green sheet.

An organic vehicle is a binder resin dissolved in organic solvent. Binder resin used for organic vehicle in the present embodiment is polyvinyl butyral resin. Polymerization degree of the polyvinyl butyral resin is 1000 or more and 1700 or less, preferably 1400 to 1700. Butyralization degree of the resin is more than 64% and less than 78%, preferably more than 64% and 70% or less, where a residual acetyl radical is less than 6%, preferably 3% or less.

Polymerization degree of polyvinyl butyral resin can be measured by the polymerization degree of its material, i.e. polyvinyl acetal resin. Butyralization degree can be measured based on JISK6728. Residual acetyl radical can be measured based on JISK6728.

The organic solvent to be used for the organic vehicle, although particularly not limited, may be terpineol, alcohol, butyl carbitol, acetone, and toluene. In the present embodiment, organic solvent preferably include alcohol solvent and aromatic solvent, wherein aromatic solvent is 10 parts by mass or more and 20 parts by mass or less with respect to 100 parts by mass of total amount of alcohol solvent and aromatic solvent. Too small content of aromatic solvent tends to increase roughness on sheet surface, while too large content deteriorates paste filtration property and also increases roughness on sheet surface.

For alcohol solvent, methanol, ethanol, propanol and butanol are exemplified. For aromatic solvent, toluene, xylene and benzyl acetate are exemplified.

Binder resin is preferably made to a solution in advance by dissolving and filtering in alcohol solvent selected at least one from methanol, ethanol, propanol and butanol, and dielectric powder and the other components are preferably added to the solution. Binder resin having a high polymerization degree is difficult to be dissolved in solvent, therefore, with conventional methods; paste dispersion property tends to deteriorate. According to the method of present embodiment, after binder resin having a high polymerization degree is dissolved in the above good solvent, ceramic powder and the other components are added to the solution, therefore, paste dispersion property can be improved and development of unsolved resin can be prevented. Note that solvents other than the above solvent are unable to raise consistency of solid content and aged deterioration of lacquer viscosity tends to increase as well.

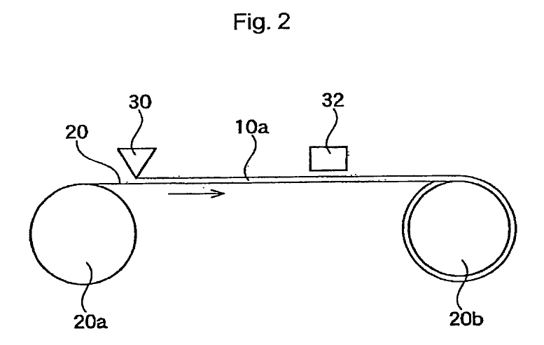

Dielectric paste may contain additives selected from a variety of dispersants, plasticizers, antistatic agents, dielectrics, glass frits and insulators, etc. in accordance with necessity. By using this dielectric paste, as shown in FIG. 2, for example, with doctor blade device 30 or so, green sheet 10a is formed on laminated film 20 surface (the surface where conductive release layer 24 is formed) which is unrolled from the first supply roll 20a wherein laminated film 20 shown in FIG. 1 is rolled. Green sheet 10a formed on laminated film 20 surface is dried with drying device 32, then rolled by the second supply roll 20b.

Drying temperature of green sheet 10a is preferably 50 to 100° C. and drying time is preferably 1 to 20 minutes. The thickness of green sheet 10a is contracted to 5 to 25% when compared to the same before drying. The thickness of green sheet after drying is preferably 1 μm or less.

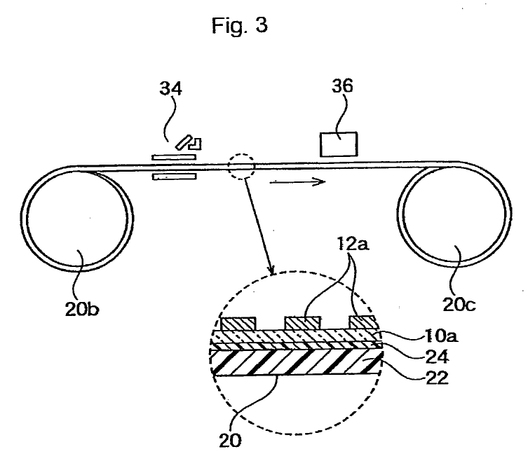

Next, as shown in FIG. 3, electrode paste layer 12a is formed by a determined pattern with screen printing device 34 on laminated film 20 comprising green sheet 10a unrolled from the second supply roll 20b, then after dried with drying device 36, rolled to the third supply roll 20c.

Electrode paste to form electrode paste layer 12a is prepared by mixing a conductive material composed of various conductive metals or alloys or various oxides to be the above conductive materials after firing, organic metal compounds or resinates, etc. with an organic vehicle.

As a conductive material to be used when manufacturing electrode paste, Ni, a Ni alloy or a mixture of these is used. A shape of the conductive material is not particularly limited and may be a sphere shape, a scale shape or a mixture of these shapes. Also, a conductive material having an average particle diameter of generally 0.1 to 2 μm, and preferably 0.2 to 1 μm or so may be used.

Organic vehicle includes binder and solvent. For the binder, ethyl cellulose, acrylic resin, polyvinyl butyral, polyvinyl acetal, polyvinyl alcohol, polyolefin, polyurethane, polystyrene or their copolymers are exemplified; however, resins having butyral group such as polyvinyl butyral is preferable.

Content of binder is preferably 8 to 20 parts by mass with respect to 100 parts by mass of conducive material (metal powder) in electrode paste. For the solvent, a well-known solvent such as terpineol, butyl carbitol and kerosene can all be used. Content of the solvent is preferably around 20 to 55% by mass with respect to a total amount of the paste.

Plasticizer is preferably included in electrode paste in order to improve adhesive property. For the plasticizer, phthalic acid ester, e.g. benzyl butyl phthalate (BBP), adipic acid, phosphate ester, glycols, etc. are exemplified. The plasticizer in electrode paste is preferably 10 to 300 parts by mass, more preferably 10 to 200 parts by mass, with respect to 100 parts by mass of binder. Note that too large additional amount of plasticizer and tackiness agent tends to extremely deteriorate strength of electrode layer 12a. Further, in order to improve transfer property of electrode layer 12a, plasticizer and/or tackiness agent is preferably added to electrode paste for improving adhesiveness and/or tackiness of electrode paste.

The third supply roll 20c is then sent to a laminate device, while not illustrated, where unrolled green sheet 10a comprising electrode paste layer 12a is removed from laminated film 20, cut into a determined size, and alternately laminated.

Note that it is possible to form electrode paste layer 12a on a surface of a laminated film different from laminated film 20 where green sheet 10a is formed, then, to form electrode pattern layer 12a on a surface of the green sheet 10a by transferring the electrode paste layer 12a on a surface of green sheet 10a.

The obtained multilayer body is cut into a predetermined size to form green chip. Next, the green chip is subjected to binder removal treatment, firing treatment and thermal treatment for re-oxidizing the dielectric layers.

The binder removal treatment may be performed under a general condition, but when Ni, a Ni alloy or other base metal are used as a conductive material of the internal electrode layer, the conditions below are particularly preferable.
Temperature raising rate: 5 to 300° C./hour,
Holding temperature: 200 to 400° C.,
Holding time: 0.5 to 20 hours,
Atmosphere gas: a wet mixed gas of N₂ and H₂
The firing conditions as shown below are preferable.
Temperature raising rate: 50 to 500° C./hour,
Holding temperature: 1100 to 1300° C.,
Holding time: 0.5 to 8 hours,
Cooling rate: 50 to 500° C./hour,
Atmosphere gas: a wet mixed gas of N₂ and H₂

An oxygen partial pressure of air atmosphere at firing is preferably 10⁻² Pa or less, especially 10⁻² to 10⁻⁸ Pa. When the oxygen partial pressure exceeds the range, the internal electrode layers tend to be oxidized, while when too low, it is liable that abnormal sintering tends to be caused in electrode materials of the internal electrode layers to result in breaking.

After the above firing, the thermal treatment is preferably performed at a holding temperature or a highest temperature of preferably 1000° C. or higher, and more preferably 1000 to 1100° C. When the holding temperature or the highest temperature during thermal treatment is less than the above range, insulation resistance lifetime tends to be shortened since oxidization of dielectric material is insufficient, while when exceeding the range, not only Ni of internal electrode oxidizes and decreases the capacitance of the invention, but reacts with dielectric basis and lifetime tends to be shortened. An oxygen partial pressure at the thermal treatment is higher than that in reducing atmosphere at firing and is preferably 10⁻³ Pa to 1 Pa, and more preferably 10⁻² Pa to 1 pa. When less than said range, dielectric layer 10 is difficult to be re-oxidized while when exceeding the range, internal electrode layer 12 tends to be oxidized.

End surface polishing, for example, by barrel polishing or sand blast, etc. is performed on the sintered body (element body 4) obtained as above, and terminal electrode paste is burnt to form terminal electrodes 6 and 8. A firing condition of the terminal electrode paste is preferably, for example, at 600 to 800° C. in a wet mixed gas of N₂ and H₂ for 10 minutes to 1 hour or so. A pad layer is formed by plating, etc. on the surface of the terminal electrodes 6 and 8, if necessary. The terminal electrode paste may be prepared as is the same with the above electrode paste.

A multilayer ceramic capacitor 2 as shown in FIG. 4 manufactured as above is mounted on a print substrate, etc. by soldering, etc. and used for a variety of electronic apparatuses, etc.

Further, according to manufacturing method of multilayer ceramic capacitor 2 of the present embodiment, even when green sheet 10a formed on laminated film 20 surface is extremely thin, e.g. around 1 μm or less, pin hole or locally thin layered part of green sheet 10a can effectively be prevented. Therefore, even with a thin-layered dielectric layer, multilayer ceramic capacitor causing less short-circuits can be manufactured.

The present embodiments are described above; however, the present invention is not limited to the above embodiments and may be variously modified within the scope of the present invention.

For example, in the above embodiment, a multilayer ceramic capacitor was explained as an example of an electronic device according to the present invention, but an electronic device according to the present invention is not limited to the multilayer ceramic capacitor and may be any as far as it includes a dielectric layer composed of a dielectric ceramic composition having the above composition. Further, laminated film of the invention can be used as a protect film to protect an optical sheet, such as polarizing plate, while processing and mounting the sheet when manufacturing liquid crystal display or as a carrier wrapping or a cover film used when transferring during manufacturing process of surface mounting chip type electronic device.

Below, the present invention will be explained based on furthermore detailed examples, but the present invention is not limited to these examples.

In the following examples and comparative examples, each physical property was evaluated as follows.

(The maximum peak height (Rp) of core layer and conducive release layer surfaces)

Measurement and analysis were made based on JIS B0601 under the following conditions.

Measurement was made by Micromap System (an optical interference style three-dimensional non-contact surface configuration measuring system) by Ryoka System Inc.

### <Measurement Conditions>

Optics Setup
Wavelength: W5600A
Objective: 50×
Body Tube: 1×Body
Relay Lens: No Relay
Camera: Sony XC-ST30 ⅓″

### Measurement Setup

Mode: Wave 560M
Averages: 1

### Format

Data Format: 640×480
Data Point: 307200
Sampling X: 1
Sampling Y: 1

10 places were measured varying the measurement places of a sample. Measurement area per one measurement is 94 μm×71 μm.

### <Analysis>

After measured by Micromap, the maximum peak height Rp was obtained using an analysis software: SX-Viewer. The largest value among the 10 measurements was determined to be the highest point. Note that the maximum peak height is a height of the highest point (the top) along Z-axis when measured from the average surface.

(Electric Resistance)

Electric resistance of conductive release layer was measured using Hiresta, a trade name by Mitsubishi Chemical Corp.

(Contact Angle)

2 μl of pure water was dropped on conductive release layer and the contact angle was measured with contact angle measurement by Kyowa Interface Science Co., Ltd.

(Coating Suitability)

Dielectric slurry was coated on dielectric release layer and dried, then, existence of cissing and nonuniformity on the slurry was visually observed. From the observation, slurry without cissing and nonuniformity was evaluated to be non-defective, while slurry with the same was evaluated to be defective.

(Release Property)

Dielectric slurry was coated on dielectric release layer and dried to form dielectric green sheet. Multilayer body of laminated film and green sheet was cut to 1 cm×4 cm size, cellophane tackiness tape was tacked to end portion of green sheet, and released the cellophane tape. When cellophane tackiness tape was released without breaking the green sheet, it was evaluated to be non-defective, while when the green sheet was broken, it was evaluated to be defective.

(Recess of Green Sheet)

Pin hole and locally thin layered part of green sheet is evaluated as follows. A surface of the above green sheet contacting the career sheet is observed by Micromap System as is the same condition with the maximum peak height of the above core layer and conductive release layer surface, and more than 100 nm recesses were observed.

(Resistance to Scratch)

Conductive release layer surface was rubbed with Bencott (by Ozu Corp.) and when the conductive release layer was not removed, it was evaluated to be non-defective, while when removed, it was evaluated to be defective.

Further, component of coating liquid to form conductive release layer was as follows; condensation reaction type release binder precursor: silicone modified aminoalkyd resin precursor (Tesfine TA31-209E by Hitachi Kasei Polymer Co., Ltd., solid content of 45% by mass)

Note that silicone modified aminoalkyd resin precursor (TA31-209E) produces silicone modified aminoalkyd resin which is a condensation reaction type release binder by condensation reaction.
Conductive polymer: polypyrrole dispersant (CDP-310M by Japan Carlit Co., Ltd., solid content of 10% by mass)
Condensation reaction catalyst: p-toluenesulfonic acid

### EXAMPLES

### Example 1

[Preparation of Coating Liquid for Forming Conductive Release Layer]

100 parts by mass of condensation reaction type release binder precursor (Tesfine TA31-209E, solid content of 45% by mass), 450 parts by mass of conductive polymer (polypyrrole dispersant, CDP-310M), 4 parts by mass of condensation reaction catalyst: p-toluenesulfonic acid, 1220 parts by mass of methyl ethyl ketone and 1230 parts by mass of toluene were mixed and the obtained mixture was filtered with a 0.8 μm mesh filter to prepare a coating liquid for forming conductive release layer.

[Formation of Laminated Film]

Polyethyleneterephthalate (PET) film not including filler (by Toyobo Co., Ltd., thickness: 38 μm, Rp: 80 nm) was made to a core layer, corona treatment was performed on one side of said core layer and the above obtained coating liquid for forming conductive release layer was coated and dried. Then, it was heated for 60 seconds at 120° C. to perform condensation reaction in condensation reaction type release binder precursor included in the coating liquid for forming conductive release layer to form a 150 nm-thick laminated film including conductive release layer on core layer. “Conductive polymer/condensation reaction type release binder (mass ratio)” in conductive release layer was 1/1. With the obtained laminated film, the above physical properties were evaluated. Results are shown in Table 1.

### Example 2

### [Preparation of Coating Liquid for Forming Conductive Release Layer]

100 parts by mass of condensation reaction type release binder precursor (TA31-209E), 225 parts by mass of conductive polymer (polypyrrole dispersant, CDP-310M), 3 parts by mass of condensation reaction catalyst: p-toluenesulfonic acid, 960 parts by mass of methyl ethyl ketone and 965 parts by mass of toluene were mixed and the obtained mixture were filtered with a 0.5 μm mesh filter to prepare a coating liquid for forming conductive release layer.

[Formation of laminated film]

The same procedures were performed as with example 1, except the above obtained coating liquid for forming conductive release layer was used. Conductive polymer/condensation reaction type release binder (mass ratio) in conductive release layer was 1/2. Results are shown in Table 1.

### Example 3

### [Preparation of Coating Liquid for Forming Conductive Release Layer]

100 parts by mass of condensation reaction type release binder precursor (TA31-209E), 150 parts by mass of conductive polymer (polypyrrole dispersant, CDP-310M), 3 parts by mass of condensation reaction catalyst: p-toluenesulfonic acid, 870 parts by mass of methyl ethyl ketone and 880 parts by mass of toluene were mixed and the obtained mixture were filtered with a 0.8 μm mesh filter to prepare a coating liquid for forming conductive release layer.

[Formation of laminated film]

The same procedures were performed as with example 1, except the above obtained coating liquid for forming conductive release layer was used. Conductive polymer/condensation reaction type release binder (mass ratio) in conductive release layer was 1/3. Results are shown in Table 1.

### Example 4

### [Preparation of Coating Liquid for Forming Conductive Release Layer]

100 parts by mass of condensation reaction type release binder precursor (TA31-209E), 113 parts by mass of conductive polymer (polypyrrole dispersant, CDP-310M), 3 parts by mass of condensation reaction catalyst: p-toluenesulfonic acid, 830 parts by mass of methyl ethyl ketone and 835 parts by mass of toluene were mixed and the obtained mixture were filtered with a 0.8 μm mesh filter to prepare a coating liquid for forming conductive release layer.

### [Formation of Laminated Film]

The same procedures were performed as with example 1, except the above obtained coating liquid for forming conductive release layer was used. Conductive polymer/condensation reaction type release binder (mass ratio) in conductive release layer was 1/4. Results are shown in Table 1.

### Comparative Example 1

### [Preparation of Coating Liquid]

100 parts by mass of polyester polyurethane (UR1400 by Toyobo Co., Ltd., solid content of 30% by mass), 9 parts by mass of curing agent (Coronate 2030 by Nippon Polyurethane Industry Co., Ltd., solid content of 50% by mass), 173 parts by mass of conductive polymer (polypyrrole dispersant, CDP-310M), 720 parts by mass of methyl ethyl ketone and 720 parts by mass of toluene were mixed and the obtained mixture were filtered with a 0.8 μm mesh filter to prepare a coating liquid.

### [Formation of Laminated Film]

The same procedures were performed as with example 1, except the above obtained coating liquid was used. Conductive polymer/crosslinked polyester polyurethane (mass ratio) in coat was 1/2. Results are shown in Table 1.

### Comparative Example 2

### [Preparation of Coating Liquid]

100 parts by mass of polyester polyurethane (UR1400 by Toyobo Co., Ltd., solid content of 30% by mass), 9 parts by mass of curing agent (Coronate 2030 by Nippon Polyurethane Industry Co., Ltd., solid content of 50% by mass), 5 parts by mass of release agent (silicone oil KF100 by Shin-Etsu Chemical Co., Ltd, solid content of 100% by mass), 720 parts by mass of methyl ethyl ketone and 720 parts by mass of toluene were mixed and the obtained mixture were filtered with a 0.8 μm mesh filter to prepare the coating liquid.

### [Formation of Laminated Film]

The same procedures were performed as with example 1, except the above obtained coating liquid was used. Results are shown in Table 1.

### Comparative Example 3

### [Preparation of Coating Liquid]

100 parts by mass of unsaturated bond-containing silicone resin precursor (KS847 by Shin-Etsu Chemical Co., Ltd, solid content of 30% by mass), 150 parts by mass of conductive polymer (polypyrrole dispersant, CDP-310M), 4 parts by mass of polymerization catalyst (unsaturated bond-containing catalyst) (CAT-PL-50T by Shin-Etsu Chemical Co., Ltd.), 620 parts by mass of methyl ethyl ketone and 630 parts by mass of toluene were mixed and the obtained mixture were filtered with a 0.8 μm mesh filter to prepare the coating liquid.

### [Formation of Laminated Film]

The same procedures were performed as with example 1, except the above obtained coating liquid was used. Conductive polymer/unsaturated bond-containing silicone resin (mass ratio) in coat was 1/2. Results are shown in Table 1.

### Comparative Example 4

### [Preparation of Coating Liquid for Forming Conductive Release Layer]

100 parts by mass of condensation reaction type release binder precursor (TA31-209E), 250 parts by mass of carbon fiber (CNF-T by JEMCO, solid content of 3% by mass), 3 parts by mass of condensation reaction catalyst: p-toluenesulfonic acid, 700 parts by mass of methyl ethyl ketone and 700 parts by mass of toluene were mixed and the obtained mixture were filtered with a 0.8 μm mesh filter to prepare a coating liquid for forming conductive release layer.

### [Formation of Laminated Film]

The same procedures were performed as with example 1, except the above obtained coating liquid for forming conductive release layer was used. Carbon fiber/condensation reaction type release binder (mass ratio) in coat was 1/6. Results are shown in Table 1.

TABLE 1

| | | The maximum peak | | | | | | | |
|---|---|---|---|---|---|---|---|---|---|
| | | (Rp:nm) | | | | | | | |
| | | | conductive | Electric | contact | | | | |
| | | core layer | release layer | Resistance | angle | coating | | greeen sheet | resistance to |
| | | surface | surface | (Ω/□) | (°) | suitability | release property | recess | scratch |
| Ex. | 1 | 80 | 90 | 1 × 10⁶ | 110 | non-defective | non-defective | none | non-defective |
| | 2 | 80 | 90 | 1 × 10⁸ | 104 | non-defective | non-defective | none | non-defective |
| | 3 | 80 | 90 | 2 × 10¹⁰ | 103 | non-defective | non-defective | none | non-defective |
| | 4 | 80 | 90 | 1 × 10¹¹ | 102 | non-defective | non-defective | none | non-defective |
| Comp. Ex. | 1 | 80 | 90 | 1 × 10⁸ | 83 | non-defective | defective | unmeasurable | non-defective |
| | 2 | 80 | 90 | 2 × 10⁸ | 102 | defective | non-defective | none | non-defective |
| | 3 | 80 | 90 | 7 × 10⁷ | 108 | non-defective | defective | unmeasurable | defective |
| | 4 | 80 | 500 | 8 × 10⁸ | 102 | non-defective | non-defective | 5 | non-defective |

1. A laminated film comprising:
a core layer made of synthetic resin, and
a conductive release layer formed on at least one side of the core layer, wherein the conductive release layer comprises condensation reaction type release binder and conductive polymer.

2. The laminated film as set forth in claim 1, wherein the condensation reaction type release binder has cross-linked structure formed by condensation reaction.

3. The laminated film as set forth in claim 1, wherein the condensation reaction type release binder is aminoalkyd resin.

4. The laminated film as set forth in claim 3, wherein the aminoalkyd resin is silicone modified aminoalkyd resin.

5. The laminated film as set forth in claim 1, wherein the conductive polymer is polypyrrole.

6. The laminated film as set forth in claim 1, wherein a mass ratio of the conductive polymer and the condensation reaction type release binder in the conductive release layer, the conductive polymer/the condensation reaction type release binder, is 1/4 to 1/1.

7. The laminated film as set forth in claim 1, wherein the maximum peak height (Rp) of the core layer surface is 200 nm or less.

8. The laminated film as set forth in claim 1, wherein the synthetic resin is polyethyleneterephthalate.

9. The laminated film as set forth in claim 1, wherein filler is substantially not included in the core layer surface.

10. A manufacturing method of the laminated film as set forth in claim 1, comprising:
a step of filtering a coating liquid for forming the conductive release layer including a precursor of the condensation reaction type release binder and the conductive polymer,
a step of coating and drying the filtrate on at least one side of the core layer made of synthetic resin, and
a step of curing the precursor of the condensation reaction type release binder by condensation reaction.

11. A manufacturing method of a multilayer ceramic electronic device comprising:
a step of pulling out the laminated film as set forth in any one of claim 1 from a roll which rolls up the laminated film,
a step of forming a green sheet on the laminated film surface,
a step of removing said green sheet from the laminated film,
a step of stacking the green sheets to form a multilayer body, and
a step of firing the multilayer body.

12. The manufacturing method of a multilayer ceramic electronic device as set forth in claim 11, further comprising a step of forming an electrode pattern layer on the green sheet surface.
